(19) United States
(12) Patent Application Publication
(10) Pub. No.: US 2006/0097611 A1
(43) Pub. Date: May 11, 2006

(54) Refrigerator

(75) Inventors: Sang Oh Kim, Seoul (KR); Seung Hwan Oh, Gunpo-si (KR); Kyung Han Jeong, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/269,690

(22) Filed: Nov. 9, 2005

(30) Foreign Application Priority Data
Nov. 10, 2004 (KR) P2004-0091271
Jun. 10, 2005 (KR) P2005-0049829

(51) Int. Cl. A47B 96/04; F25D 19/00; B65G 1/00; B65G 65/00

(52) U.S. Cl. 312/402; 62/298; 414/288

(57) ABSTRACT

A refrigerator includes a body having a compartment therein and a door opening and closing the compartment; an electrical device movable with respect to the body along a first direction; a conductor electrically connecting the electrical device with the body; and a structure for accommodating a slack portion of the conductor generated when the electrical part moves along the first direction.

This Nonprovisional Application claims priority under 35 U.S.C. §119(a) on Patent Application No. 10-2004-0091271 filed in Korea on Nov. 10, 2004 and Patent Application No. 10-2005-0049829 filed in Korea on Jun. 10, 2005, the entire contents of which are hereby incorporated by reference.

### BACKGROUND OF THE INVENTION

1. Field of the Invention

The present invention relates to a refrigerator, and more particularly, to a mechanism electrically connecting a body of the refrigerator with an electrical device which is mounted on a door or a part of the refrigerator movable with respect to the body of the refrigerator.

2. Discussion of the Related Art

Conventional refrigerators are usually classified into three types, i.e., a top mount freezer type, a side by side type, and a bottom mount freezer type. In the top mount freezer type refrigerator, a freezing compartment is provided on an upper portion of the refrigerator and a refrigerating compartment is provided at a lower portion of the refrigerator. In the side by side type refrigerator, a freezing compartment and a refrigerating compartment are respectively arranged on a left portion and a right portion of a refrigerator. In the bottom mount freezer type refrigerator, a freezing compartment is provided on a lower portion of the refrigerator and a refrigerating compartment is provided on an upper portion of the refrigerator.

Electrical devices, such as a display panel, an ice and a water dispenser, etc., are usually provided on a door of a refrigerator. The electrical device is electrically connected with a body of the refrigerator by a conductor. The conductor supplies electrical power from a power source provided in the body of the refrigerator or sends a signal from a controller of the refrigerator and vice versa. The door and the body of the refrigerator are usually coupled by a hinge and the conductor is arranged to pass through the hinge in order to electrically connect the electrical device on the door and the body of the refrigerator.

Meanwhile, it is very uncomfortable for the user to use the freezing compartment mounted at the lower portion of the refrigerator when the door is simply open by rotating about the hinge, because the user has to kneel and bend his or her body and stretch his/her hands into an inside of the freezing compartment mounted on the lower portion of the refrigerator.

### SUMMARY OF THE INVENTION

Accordingly, the present invention is directed to a refrigerator that substantially obviates one or more problems due to limitations and disadvantages of the related art.

An object of the present invention is to provide a refrigerator which can elevate a compartment provided at a lower portion of the refrigerator when the door is open for the user's convenience and a mechanism for electrically connecting a device for elevating the compartment with the body.

The other object of the present invention is to provide a refrigerator having a mechanism which can electrically connect a body of the refrigerator with an electrical device mounted on a door coupled with the body without a hinge or mounted on a part of the refrigerator movable with respect to the body.

Another object of the present invention is to prevent a conductor electrically connecting the electrical device with the body from being damaged by a movement of the door or other parts of the refrigerator.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in one aspect of the present invention, a refrigerator includes a body having a compartment therein and a door opening and closing the compartment; an electrical device movable with respect to the body along a first direction; a conductor electrically connecting the electrical device with the body; and a structure for accommodating a slack portion of the conductor generated when the electrical part along the first direction.

The electrical device may be movable forward or backward with respect to the body along the first direction.

The refrigerator in accordance with the present invention may further include a container provided in the compartment, wherein the electrical device includes an elevating device elevating the container.

In one embodiment, the structure may include a peg on which the conductor is hung. The slack portion of the conductor is formed below the peg along the first direction. The conductor may include a bent portion whose upper part is supported by the peg and lower part of the bent portion is movable along the first direction when the electrical device moves along the first direction. The lower part of the conductor may be bendable along a direction parallel to the upper part of the conductor. The bent portion may have an “S” figure.

The refrigerator in accordance with the present invention may further include a plurality of rails guiding a movement of the door. The conductor may pass through the rails, wherein the structure may include a peg, secured to the rail, on which the conductor is hung. The rails may have a space therein between the peg and a bottom thereof so that the conductor is bent within the rails without interfering with a movement of the rails when the door moves. The conductor may include a bent portion whose upper part is supported by the peg and lower part of the bent portion is movable along the first direction when the electrical device moves along the first direction.

The refrigerator in accordance with the present invention may further include a conductor guide extendable and retractable along a longitudinal direction thereof according to a movement of the electric part, wherein the conductor passes through the conductor guide. The conductor may pass through the conductor guide, wherein the structure may include a peg, secured to the conductor guide, on which the conductor is hung.

Alternatively, the structure may include a conductor pocket receiving the slack portion of the conductor formed by the gravity to protect the slack portion of the conductor when the electrical device moves. The pocket may include an open top through which the slack portion of the conductor is inserted; and a pocket cover secured to an inner surface of the compartment to protect the slack portion of the conductor.

The structure may further include a supplemental conductor guide guiding the slack portion of the conductor into the conductor pocket. The conductor may be configured to pass through the supplemental conductor guide. The conductor may be secured to the supplemental conductor guide.

The supplemental conductor guide may include a first end coupled to either of the door or a member secured to the door, and a second end extended from the first end to the conductor pocket to guide the slack portion of the conductor into the pocket. The first end may be configured to be coupled to either of the door or the member by a pivot. The second end may be arranged to be located in the pocket and to avoid escaping out of the pocket when the electrical device fully moves forward with respect to the body. The second end may be configured to be sloped downwards to guide the conductor into the pocket.

The structure may further include a protrusion allowing the supplemental guide to rotate downwards when the door is closed. The protrusion may be located in the compartment to be in contact with an upper part of the supplemental guide when the door is closed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 illustrates a perspective view of a refrigerator according to an embodiment of the present invention;

FIG. 2 illustrates a schematic cross-sectional view of a lower portion of the refrigerator in accordance with a first embodiment of the present invention when a door is open;

FIG. 3 illustrates a perspective view of an elevating device mounted on the door of the refrigerator shown in FIG. 1;

FIG. 4 illustrates a partial perspective view of a conductor connection mechanism in accordance with the first embodiment of the present invention;

FIGS. 5 and 6 illustrate schematic diagrams for showing a working process of the conductor connection mechanism of FIG. 4 when the door is open and closed, respectively;

FIG. 7 illustrates a schematic cross-sectional view of the lower portion of the refrigerator in accordance with a variation of the first embodiment of the present invention;

FIG. 8 illustrates a partial schematic cross-sectional view of the lower portion of the refrigerator in accordance with a second embodiment of the present invention;

FIG. 9 illustrates a partial perspective view for showing a conductor pocket, for preventing a conductor from being damaged when the door moves, in accordance with the second embodiment of the present invention;

FIG. 10 illustrates a schematic cross-sectional view of the lower portion of the refrigerator in accordance with the second embodiment of the present invention when the door is open; and

FIG. 11 illustrates a schematic cross-sectional view of the lower portion of the refrigerator in accordance with the second embodiment of the present invention when the door is closed.

### DETAILED DESCRIPTION OF THE ILLUSTRATED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

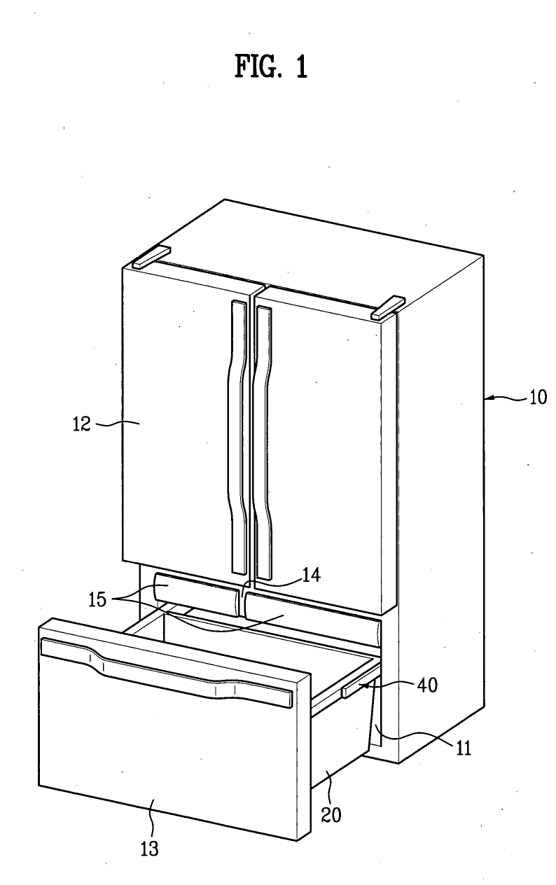

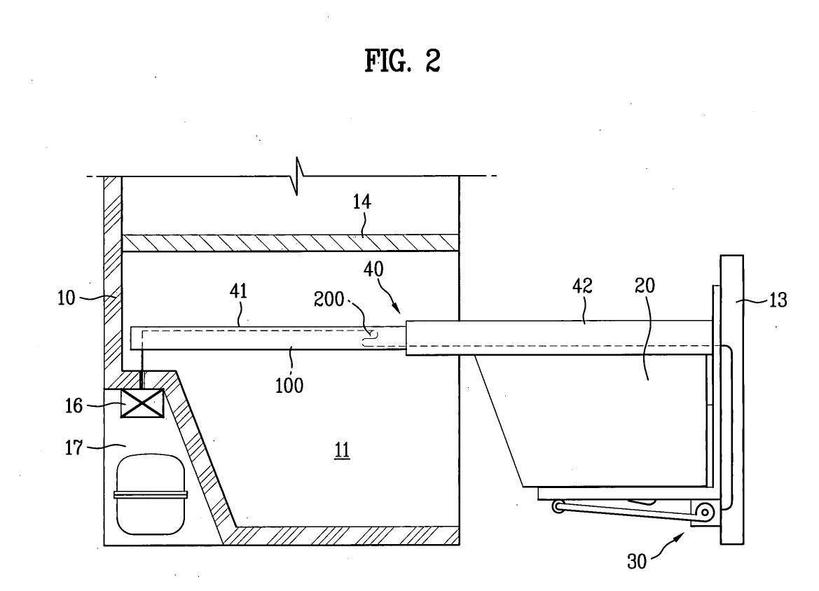

Referring to FIG. 1, a refrigerator according to an embodiment of the present invention includes a body 10, compartments provided in the body 10, and doors 12 and 13 for opening/closing the compartments. The compartments, for example, include a refrigerating compartment (not shown) provided in an upper portion of the body 10 and a freezing compartment 11 provided in a lower portion of the body 10. Alternatively, it is possible that the refrigerating compartment is located in the lower portion of the body 10 and the freezing compartment is located in the upper portion of the body 10. A horizontal partition wall 14 divides an inside space of the body 10 into the refrigerating compartment and the freezing compartment 11. A mechanical component chamber 17 for accommodating a compressor, a condenser, etc. is provided in the lower portion of the body 10, especially at a rear of the freezing compartment 11 as shown in FIG. 2.

A pair of doors 12 is coupled to the body 10 by a hinge. The doors 12 rotate about the hinge with respect to the body 10 for opening and closing the refrigerating compartment. The door 13 is provided at the lower portion of the body 10 for opening and closing the freezing compartment 11 at the lower portion of the body 10. The door 13 moves forward and backward with respect to the body 10 and the door 12 rotates about the hinge. Therefore, no hinge or pivot is necessary for the door 13 to be coupled with the body 10.

A plurality of rails 40 are provided between the body 10 and the door 13 for smoothly guiding a sliding movement of the door 13 as shown in FIGS. 1 and 2. The rails 40 are arranged at both sides of the door 13, and include a first rail 41 secured to the body 10 and a second rail 42 secured to a backside of the door 13. Alternatively, a bracket 25 firmly secured to the backside of the door 13 may be provided and the second rail 42 may be secured to the bracket 25 as shown in FIG. 12.

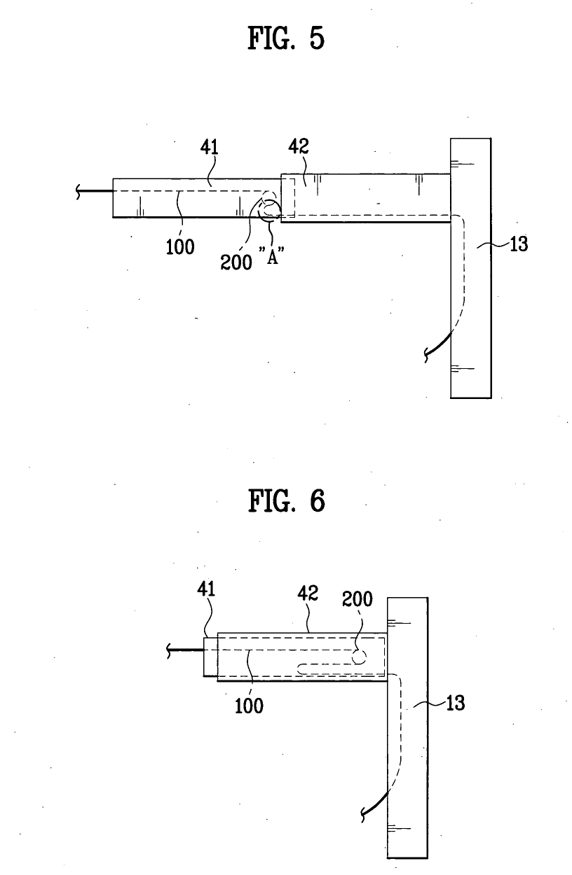

The first rail 41 is able to move with respect to the second rail 42 by sliding and vice versa. For a smooth sliding of the first and the second rails 41 and 42, a plurality of balls or rollers may be provided between the first and the second rails 41 and 42. The first rail 41 may be arranged on the second rail 42 and vice versa. Alternatively, the first rail 41 may be inserted into the second rail 42 as shown in FIG. 5 and vice versa. Meanwhile, the rails 40 may include three or more than three rails connected to each other.

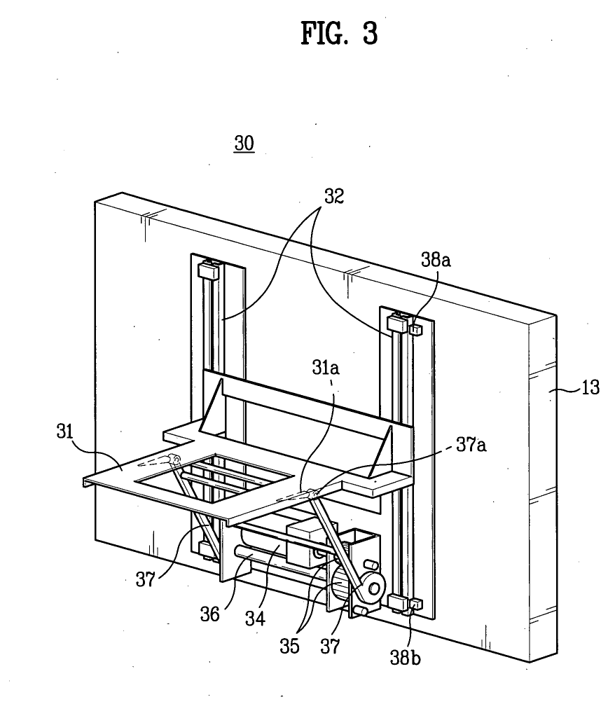

At least one container 20 for storing food therein is provided in the freezing compartment 11 at a lower portion of the freezing compartment 11 as shown in FIGS. 1 and 2, and at least one drawer 15 is provided above the container 20 in the freezing compartment 11 as shown in FIG. 1. The container 20 moves forward and backward with respect to the body 10 along with a movement of the door 13 while the drawer 15 is movably independent of the movement of the door 13. For the user's convenience, the container 20 may be automatically elevated when the door 13 is fully open. In an embodiment, an elevating device 30 is provided to the refrigerator as shown in FIGS. 2 and 3. The elevating device is secured to a rear surface of the door 13 and the container 20 is seated on and supported by the elevating device 20.

FIG. 3 illustrates a mechanism of the elevating device 30 in detail. The detailed mechanism of the elevating device 30 will be described referring to FIG. 3. As shown in FIG. 3, the elevating device 30 includes a lifter 31 on which the container 20 is seated, a pair of elevating rails 32 secured to the door 13 for guiding an elevating movement of the lifter 31, and a driving unit for automatically elevating the lifter 31.

The lifter 31, for example, has an “L” shaped bent form. A vertical portion of the lifter 31 is coupled with the pair of elevating rails 32 vertically secured to the backside of the door 13 and a horizontal portion of the lifer 31 supports the container 20 seated thereon. The lifter 31 moves upward and downward along the elevating rails 32 by the driving unit when the door 13 is open.

The driving unit includes at least one arm 37 rotatable with respect to the door 13, a motor 34, a gear assembly 35 coupled with a shaft of the motor 34, a driving shaft 36 coupled with the gear assembly 35 and the arm 37 to rotate the arm 37. In the illustrate embodiment, there two arms 37 arranged at both sides of a lower portion of the backside of the door 13. The motor 33 is secured to the rear of the door 13 and arranged between the two arms 37. The motor 34 is controlled by a controller (not shown) of the refrigerator or by a sub controller (not shown) for operating the motor 34 independent of the controller.

A roller 37a is provided at an end of the arm 37 to support a bottom surface of the lifter 31. The roller 37a rolls forward and backward on the bottom surface of the lifter 31 when the arm 37 is rotated by the motor 34. A slant projection 31a is provided on the bottom of the lifter 31 as shown in FIG. 3 and the roller 37a rolls over the projection 31a when the lifter 31 is fully elevated. Therefore, it can prevent the lifter 31, when fully elevated, from falling downward even if the motor 34 stops because the roller 37a is supported by the projection 31a.

There are an upper sensor 38a on top of the elevating rail 32 and a lower sensor 38b on bottom of the elevating rail 32. The upper sensor 38a and the lower sensor 38b detect the lifter 31 at the top or the bottom of the elevating rail 32, respectively, and send a signal to the controller. After receiving the signal, the controller stops the motor 34. Therefore, a movement range of the lifter 31 is limited and it would prevent the lifter 31 from being derailed from the elevating rail 32. Alternatively, there may be an upper limit switch (not shown) on the top of the elevating rail 32 and a lower limit switch (not shown) on the bottom of the elevating rail 32. The upper limit switch and the lower limit switch can directly stop the motor 34 by cutting off the power supplied to the motor 34.

In an embodiment, the lifter 31 is automatically elevated as soon as the door 13 is fully open or after the door 13 is fully open for a predetermined time passes, and the fully lifted lifter 31 automatically moves downward as soon as the door 13 is slightly pushed to be closed. Alternatively, a control button (not shown) may be provided on the doors 12 or 13 in order that the user can control the elevating device 30 by pushing the control button.

When the control button is pushed or a predetermined time passes after the door 13 is fully open, the motor 34 starts to work. Then, the gear assembly 35 runs by the motor 34 to rotate the driving shaft 36. As the driving shaft 36 is rotated, the arm 37 is getting rotated and the roller 37a at the end of the arm 37 is getting raised while rolling on the bottom of the lifter 37. Therefore, the lifter 31 is also getting raised along with the container 20 which is seated on the lifter 31. When the lifter 31 is fully lifted, the upper sensor 38a detects the lifter 31 and sends a signal to the controller. After receiving the signal, the controller stops the motor 34 and therefore stops an elevating movement of the lifter 31. At this time, the roller 37a at the end of the arm 37 is engaged with and supported by one side of the slant projection 31a. Therefore, the reverse movement of the arm 37 and the downward movement of the lifter 31 along with the container 20 due to the gravity can be effectively prevented.

Meanwhile, after taking the food out of the container 20 or putting new food into the container 20, the user pushes the control button or slightly pushes the door 13 towards the body 10 of the refrigerator. Then, the motor 34 reversely rotates its shaft. Therefore, the lifter 31 and the container 20 move downward together. In case that the lifter 31 and the container 20 fully come down, the lower sensor 38b and the controller stop a downward movement of the lifter 31. Then, the user can put the container 20 into the freezing compartment 11 by pushing the door 13 toward the body 10.

As mentioned above, the elevating device 30 movable with respect to the body 10 of the refrigerator along with the door 13 is supplied power from a power source 16 (shown in FIG. 2) in the body 10 of the refrigerator. Alternatively, it is possible that the other electrical devices, such as a display panel or a touch panel, etc., provided on the door 13 may need the electrical power. Further, it is also possible that another electrical device, such as a sensor, etc., communicating with the controller to send a signal, may be provided on the door 13. In these cases, it is necessary that the electrical devices movable with respect to the body 10 be connected with at least one of the power source 16 and the controller in the body 10 by a conductor such as a power cable or a signal cable.

An embodiment of the present invention provides a conductor 100 to electrically connect the electrical device movable with respect to the body 10 with the power source 16 or the controller in the body 10. The conductor 100 includes at least one of the power conductor and the signal conductor. Since the electrical device is movable while the power source 16 or the controller is not movable with respect to the body 10, the conductor 100 is slack or tightened while the electrical device moves with respect to the body 10 of the refrigerator. Therefore, the conductor 100 is likely to be tangled or damaged by other parts of the refrigerator when the electrical device moves along with the door 13.

The present invention therefore presents a structure for accommodating a slack portion of the conductor generated when the electrical part along the first direction to prevent the conductor from being tangled and damaged when the electrical device moves with respect to the body 10. The structure is embodied as various embodiments in the present invention as shown in FIGS. 2 and 4 through 11. Each embodiment of the structure will now be described step by step referring to the drawings corresponding to each embodiment. In addition, in the illustrated embodiments, the first direction is the horizontal direction. However, it should be noted that the present invention can apply to any direction along which the electrical device or the door moves.

The structure according to a first embodiment of the present invention includes a peg 200 on which the conductor 100 is hung as shown in FIGS. 2 and 4 through 7. The peg 100 is located at and supports a substantially middle portion of the conductor 100. Since the peg 200 supports the middle portion of the conductor 100, the conductor 100 is not slack too much when the door 13 is closed. In addition, an enough space is provided below the peg 200 so that the slack portion of the conductor 100 is formed below the peg 200 without being tangled. More particularly, the conductor 100 is bent below the peg 200 along a direction parallel to the longitudinal direction of the conductor 100 when the door 13 is closed as shown in FIG. 6.

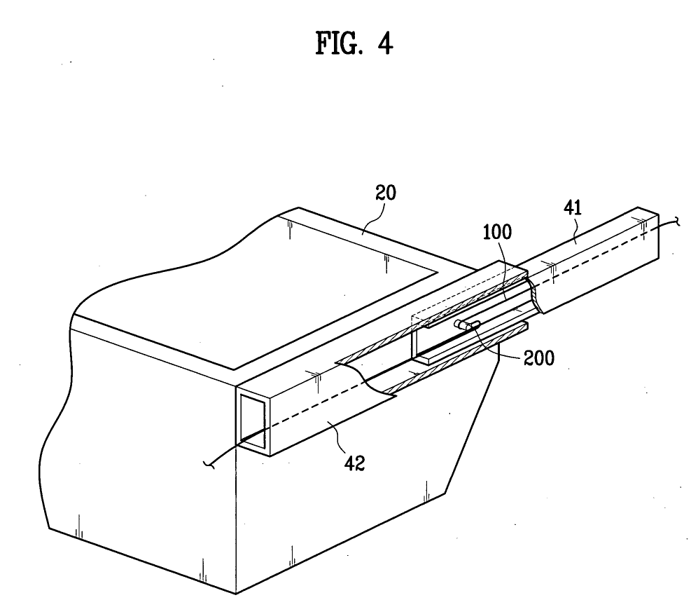

To make the conductor 100 bent without being tangled, it is preferable, but not necessary, that the conductor 100 includes a bent portion at the middle portion thereof as shown in FIGS. 2 and 4. The bent portion of the conductor 100 may have an “S” figure. More particularly, an upper part of the bent portion of the conductor 100 is hung on and supported by the peg 200. The upper part of the bent portion may be permanently bent so as to be securely hung on the peg 200 while the electrical device and the door 13 move with respect to the body 10 of the refrigerator. To avoid being tangled, the lower portion of the conductor 100 is bent along a direction parallel to the upper part of the conductor 100.

It is possible that the conductor 100 is exposed. However, to protect the conductor 100 more safely, it is preferable, but not necessary, that the conductor 100 is encompassed by other parts of the refrigerator. An embodiment of the present invention presents the structure that the conductor 100 is arranged to pass through the rails 40 guiding the movement of the door 13, as shown in FIGS. 2 and 4. Therefore, the conductor 100 is encompassed and securely protected.

More particularly, the first and the second rails 41 and 42 may have a hollow pillar shape, respectively, and the first rail 41 is insertable into the second rail 42 along a longitudinal direction of the second rail 42 as shown in FIG. 4 and vice versa. In addition, the conductor 100 is arranged to pass through the first and the second rails 41 and 42 at the same time.

In this case, the peg 200 is provided in and secured to the first rail 41 as shown in FIG. 4. In addition, the space is secured between the peg 200 and a bottom of the first rail 41. The space is spacious so that the slack portion of the conductor 10 is bent in the rails 41 and 42 without being tangled and interfering with the movement of the rails 41 and 42 when the door 13 moves.

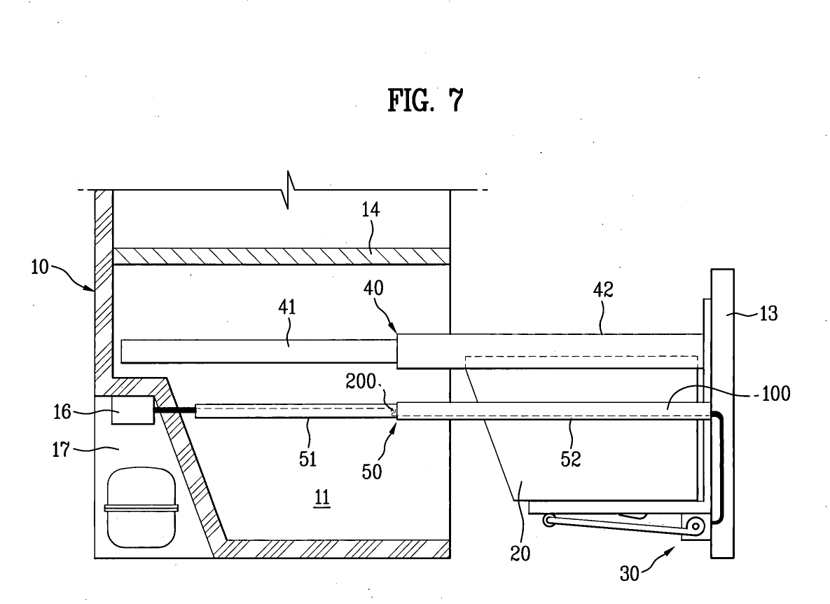

Alternatively, it is possible that a conductor guide 50, distinct from the rails 41 and 42, is provided to the refrigerator according to the first embodiment, the conductor 100 is arranged to pass through the conductor guide 50, and the peg 200 is provided in and secured to the conductor guide 50 as shown in FIG. 7. The conductor guide 50 is extendable and retractable along a longitudinal direction thereof according to the movement of the electrical device, i.e., the elevating device 30 or the door 13.

More particularly, the conductor guide 50 includes a first guide 51 secured to the body 10 of the refrigerator and a second guide 52 directly secured to the door 13 or secured to a supporter firmly secured to the door 13. The first guide 51 may be overlapped with the second guide 52 when the door 13 is closed by being inserted into the second guide 52 along a longitudinal direction of the second guide 52 and vice versa.

Therefore, the conductor guide 50 is extendable and retractable along a longitudinal direction thereof by a relative movement of the first and the second guides 51 and 52 according to the movement of the electrical device or the door 13. These mechanisms are very similar to those of the first and the second rails 41 and 42, and the configuration of the conductor 100 provided in the conductor guide 50 is very similar as described above referring to FIGS. 2 and 4 to 6. Therefore more detailed descriptions regarding the embodiment shown in FIG. 7 will be omitted.

In the embodiment shown in FIG. 7, the movement of the door 13, forward and backward with respect to the body 10 in order to open and close the freezing compartment 11, is smoothly guided by the first and the second rails 41 and 42, and the conductor 100 is stably protected by the first and the second guides 51 and 52. Meanwhile, although it is not shown in the drawings, the conductor guide 50 may include three or more than three guides connected with each other.

In operation, the conductor 100 is almost stretched along a longitudinal direction thereof, except the bent portion at the substantially middle portion thereof and hung on the peg 200, as shown in FIGS. 2 and 5 when the door 13 is fully open. The bent lower part of the bent portion faces towards the body 10 of the refrigerator.

A lower part of the bent portion is movable along the horizontal direction when the electrical device moves along the horizontal direction. For example, in the illustrated embodiment, the lower part of the bent portion moves in the horizontal direction toward the compartment as shown in FIG. 6 when the electrical device or the door 13 moves toward the body 10. On the other hand, the lower part of the bent portion moves in the horizontal direction away from the compartment as shown in FIG. 5 when the electrical device or the door 13 moves away from the body 10. The conductor 100 above the peg 200 has a fixed length in the horizontal direction. The length of the slack portion of the conductor 100 below the peg 200 in the horizontal direction increases when the electrical device moves in the horizontal direction toward the compartment and decreases when the electrical device moves in the horizontal direction away from the compartment. Therefore, the cable 100 is prevented from being tangled when the door 13 moves with respect to the body 10 and does not interfere with the movement of the door 13.

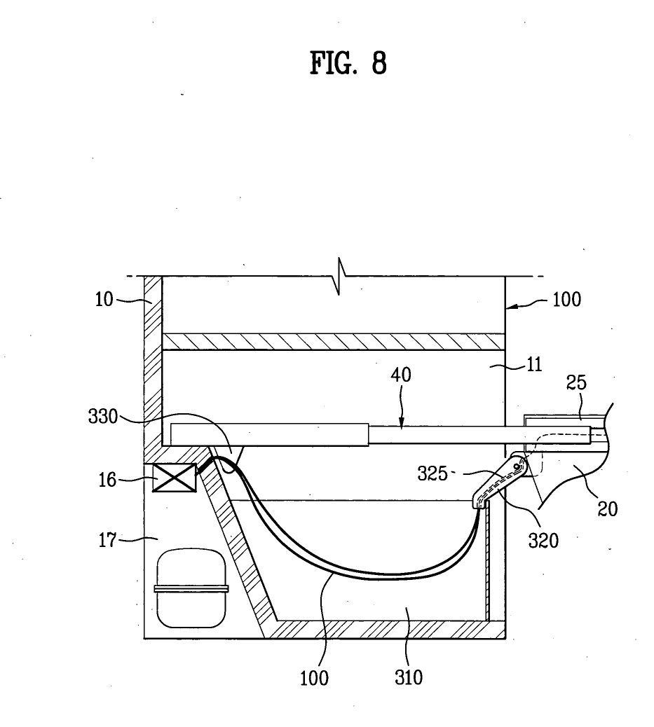

The structure according to a second embodiment of the present invention includes a conductor pocket 310 which receives the slack portion of the conductor 100 formed by the gravity as shown in FIGS. 8 to 11. The conductor pocket 310 accommodates the slack portion of the conductor 100 therein and cover it, therefore no other parts of the refrigerator and/or the user's hands is contactable with the slack portion of the conductor 100. Therefore, the slack portion is securely protected. The detailed structure of the conductor pocket 310 will be described referring to the above-mentioned drawings.

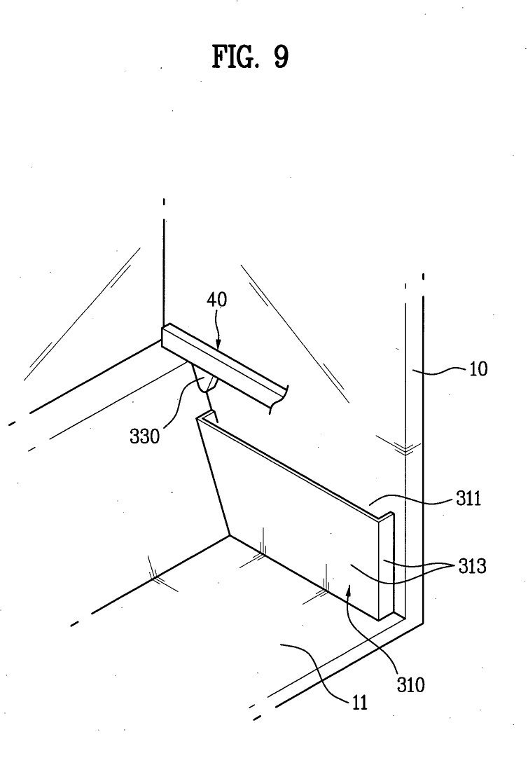

The conductor pocket 310 is located between a side of the container 20 and the body 10, for example, a sidewall of the freezing compartment 11 as shown in FIG. 9. The conductor pocket 310, as shown in FIG. 9, includes an open top 311 through which the slack portion of the conductor 100 is inserted, and a pocket cover 313 secured to the sidewall of the freezing compartment 11 forming a space in which the slack portion of the conductor 100 is accommodated.

It is preferable, but not necessary, that the conductor pocket 310 is located below the conductor 100 which connects the electrical device on the door 13 with the power source 16 or the controller in the body 10. Then, the slack portion of the conductor 100 formed by the gravity is naturally inserted into the conductor pocket 310 through the open top 311 and protected by the pocket cover 313.

The structure according to the second embodiment of the present invention may further include a supplemental conductor guide 320 that guides the slack portion of the conductor 100 into the conductor pocket 310 as shown in FIG. 8. The supplemental conductor guide 320 will prevent the slack portion of the conductor 100 from being out of the conductor pocket 310. The supplemental conductor guide 320 includes a first end and second end. The detailed structure of the supplemental conductor guide 320 is as follows.

The first end of the supplemental conductor guide 320 may be directly coupled to the door 13. For example, the first end may be arranged at a side portion of the door 13. Alternatively, the first end of the supplemental conductor guide 320 may be coupled to a member secured to the door 13, for example, the bracket 25 to which the rail 40 is secured. Alternatively, the first end of the supplemental conductor guide 320 may be coupled to the rail 40, more particularly, the second rail 42. The second end of the supplemental conductor guide 320 extends from the first end towards an inner space of the conductor pocket 310.

The conductor 100 is arranged to pass through the supplemental conductor guide 320. In an embodiment, a passage 325 is provided in the supplemental conductor guide 320 from the first end to the second end. More particularly, the conductor 100 enters into the supplemental conductor guide 320 through the first end and comes out of the supplemental conductor guide 320 through the second end after passing through the passage 325, as shown in FIG. 8. A portion of the conductor 100 which passes through the supplemental conductor guide 320 may be secured to the supplemental conductor guide 320. A portion of the conductor 100 which comes out of the second end of the supplemental conductor guide 320 goes into the conductor pocket 310, because the second end of the supplemental conductor guide 320 faces to the inner space of the conductor pocket 310.

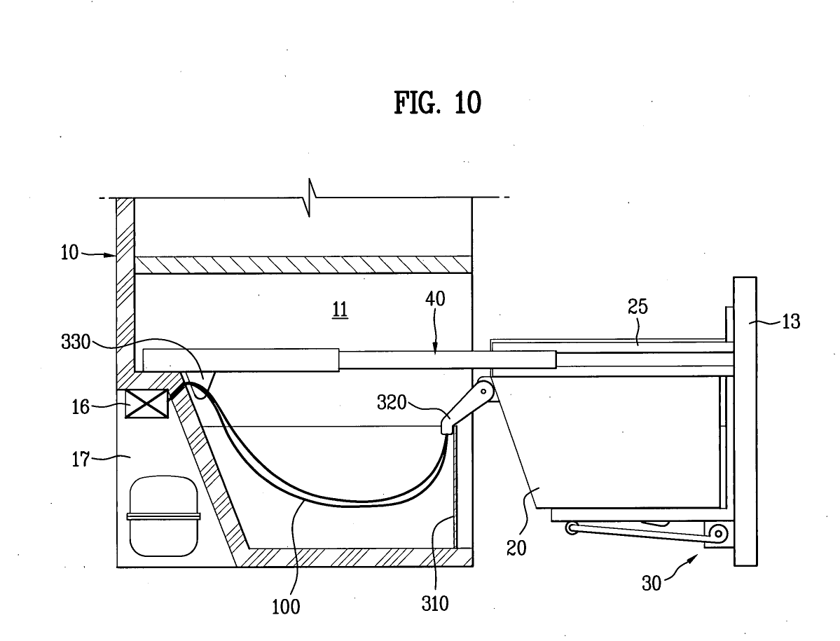

It is preferable, but not necessary, that the second end of the supplemental conductor guide 320 is inserted into the conductor pocket 320 through the open top regardless of the location of the electrical device and the door 13. More particularly, the second end of the supplemental conductor guide 320 is located in the conductor pocket 310 when the door 13 is fully open, as shown in FIG. 10. Then, the slack portion of the conductor 100 is always guided into the conductor pocket 310. Therefore, the conductor pocket 310 can prevent the slack portion of the conductor 100 from escaping out of the conductor pocket 310 while the electrical device and the door 13 move.

In addition, it is preferable, but not necessary, that the second end of the supplemental conductor guide 320 slopes downward with a predetermined angle, as shown in FIG. 8. Therefore, the slack portion of the conductor 100 cannot escape out of the pocket 310 when the electrical device fully moves forward with respect to the body 10.

The supplemental conductor guide 320 is located at a rear space of the container 20 and the conductor 100 is covered by the supplemental conductor guide. Therefore, the conductor 100 is not exposed to an outside of the refrigerator even when the door 13 is fully open, as shown in FIG. 8. Thereby, there is no possibility that the user receives an electric shock by touching the conductor 100 or that the conductor 100 is damaged.

It is preferable, but not necessary, that the first end of the supplemental conductor guide 320 is coupled to the door 13 or the member by a pivot so that the supplemental conductor guide 320 is rotatable about the pivot. Then, the supplemental conductor guide 320 can rotate within a predetermined angle range while the conductor 100 is loosened and tighten according to the movement of the door. Thus, the supplemental conductor guide 320 does not interfere with a movement of the conductor 100 during the movement of the door 13. Therefore, the conductor 100 is not damaged by the supplemental conductor guide 320.

When the door 133 is open, the supplemental conductor guide 320 is rotated relatively upwards arranged to be nearly horizontal because the conductor 100 is tightened. It is possible that the supplemental conductor guide 320 is crashed to the body 10 of the refrigerator when the door 13 is fully closed in case that the pivot becomes too stiff to be rotated downwards. To prevent this problem, the structure in accordance with the second embodiment of the present invention may further include a protrusion 330, as shown in FIGS. 8 to 11.

The protrusion 330 is located in the compartment, i.e., the freezing compartment 11. More particularly, the protrusion 330 may extends from the inner surface of the freezing compartment 11. Alternatively, the protrusion 330 may extends from the rail 40, more particularly, the first rail 41, as shown in FIG. 9. The protrusion 330 is in contact with an upper part of the supplemental guide 320, more particularly, an upper part of the second end when the door 13 is nearly fully closed. Therefore, the protrusion 330 forces the supplemental conductor guide 320 to rotate downwards, when the door 13 is nearly fully closed, in order to prevent the supplemental conductor guide 320 from being crashed to the body 10.

Meanwhile, it is possible that the conductor 100 may be damaged by a tension thereof if the conductor 100 is tightened too much when the door 13 is fully open. To prevent this problem, the conductor 100 may be slack a little bit when the door 13 is fully open, as shown in FIG. 10. Then, the conductor 100 is naturally slack a little bit when the door 13 is fully open, as shown in FIG. 10. Therefore, the damage of the conductor 100 by an excessive tension is effectively prevented.

In operation, the supplemental conductor guide 320 moves forward and backward with respect to the body 10 along with the movement of the door 13. When the door 13 is getting open, the supplemental conductor guide 320 moves forward with respect to the body 10 and the conductor 100 accommodated in the conductor pocket 310 is getting tightened, as shown in FIGS. 8 and 10. As mentioned above, the slack portion of the conductor 100 is located in and protected by the conductor pocket 310 while the door 13 is getting open.

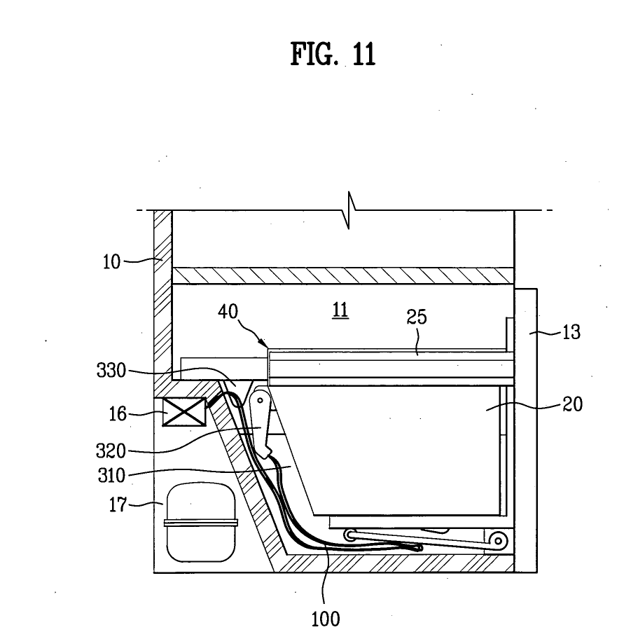

When the door 13 is getting closed, the supplemental conductor guide 320 moves backward with respect to the body 100 and the conductor 100 tightened is getting loosened. The supplemental conductor guide 320 guides the slack and loosened portion of the conductor 100 into the conductor pocket 310 while the door 13 is getting closed. The loosened portion of the conductor 100 is eventually uniformly folded at the bottom of the conductor pocket 310, and therefore the conductor 100 is not tangled, as shown in FIG. 11.

Meanwhile, as described above, the refrigerator according to the first and the second embodiment of the present invention has the following advantages.

The refrigerator according to the present invention provides the elevating device which enables the container in the compartment at the lower portion of the refrigerator to be elevated when the door is open. Therefore, it is not necessary that the user kneels down and bends over his or her body to take out food from or put food into the container. Therefore, the refrigerator according to the present invention is very easy and convenient to use.

In addition to this, the present invention provides the structure preventing the conductor from being tangled and damaged when the electrical device and the door move with respect to the body. Therefore, the present invention enables the conductor to electrically connect the body of the refrigerator with the electrical device or the door even if the electrical device or the door is movable forward and backward with respect to the body.

Further, in the present invention, the conductor is encompassed by the rails guiding the movement of the door, the conductor guide, or the conductor pocket while the electrical device and the door move with respect to the body of the refrigerator. Therefore, the conductor is effectively protected from damage by other parts of the refrigerator. In addition, since the user cannot touch the conductor when the door is open, the user is securely protected from receiving electric shock.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A refrigerator, comprising:
a body having a compartment therein and a door opening and closing the compartment;
an electrical device movable with respect to the body along a first direction;
a conductor electrically connecting the electrical device with the body; and
a slack accommodating structure that accommodates a slack portion of the conductor generated when the electrical part moves along the first direction.

2. The refrigerator of claim 1, wherein the first direction is a horizontal direction.

3. The refrigerator of claim 1, wherein the electrical device is movable along the first direction when the door moves along the first direction.

4. The refrigerator of claim 1, further comprising a container provided in the compartment, wherein the electrical device includes an elevating device for elevating the container.

5. The refrigerator of claim 1, wherein the slack accommodating structure includes a peg on which the conductor is hung.

6. The refrigerator of claim 5, wherein the slack portion of the conductor is formed below the peg along the first direction.

7. The refrigerator of claim 5, wherein the conductor includes a bent portion, an upper part of the bent portion being supported by the peg, a lower part of the bent portion being movable along the first direction when the electrical device moves along the first direction.

8. The refrigerator of claim 7, wherein the length of the slack portion of the conductor below the peg in the first direction increases when the electrical device moves in the first direction toward the compartment and decreases when the electrical device moves in the first direction away from the compartment.

9. The refrigerator of claim 8, wherein the conductor above the peg has a fixed length in the first direction.

10. The refrigerator of claim 7, wherein the bent portion has an “S” figure.

11. The refrigerator of claim 1, further comprising a plurality of rails guiding a movement of the door along the first direction.

12. The refrigerator of claim 11, wherein the conductor passes through the rails and the slack accommodating structure includes a peg, secured to the rail, on which the conductor is hung.

13. The refrigerator of claim 12, wherein the rails have a space therein between the peg and a bottom of the rails so that the slack portion of the conductor is within the space without interfering with a movement of the rails when the door moves along the first direction.

14. The refrigerator of claim 12, wherein the conductor includes a bent portion, an upper part of the bent portion being supported by the peg, a lower part of the bent portion being movable along the first direction when the electrical device moves along the first direction.

15. The refrigerator of claim 1, further comprising a conductor guide extendable and retractable along the first direction when the electric device moves along the first direction, wherein the conductor passes through the conductor guide.

16. The refrigerator of claim 15, wherein the slack accommodating structure includes a peg, secured to the conductor guide, on which the conductor is hung.

17. The refrigerator of claim 1, wherein the slack accommodating structure includes a conductor pocket for receiving the slack portion of the conductor formed by the gravity.

18. The refrigerator of claim 17, wherein the conductor pocket has an open top through which the slack portion of the conductor is inserted, the open top being surrounded by an inner sidewall of the compartment and a pocket cover secured to the inner sidewall.

19. The refrigerator of claim 17, wherein the slack accommodating structure further includes a supplemental conductor guide for guiding the slack portion of the conductor into the conductor pocket.

20. The refrigerator of claim 19, wherein the conductor passes through the supplemental conductor guide.

21. The refrigerator of claim 19, wherein the conductor is secured to the supplemental conductor guide.

22. The refrigerator of claim 19, wherein the supplemental conductor guide includes:
a first end coupled to either of the door or a member secured to the door; and
a second end extended from the first end towards the conductor pocket to guide the slack portion of the conductor into the conductor pocket.

23. The refrigerator of claim 22, wherein the first end is coupled to either of the door or the member by a pivot.

24. The refrigerator of claim 22, wherein the second end is located in the conductor pocket and further enters into the conductor pocket when the door is fully closed than when the door is open.

25. The refrigerator of claim 22, wherein the second end is sloped downwards to guide the conductor into the conductor pocket.

26. The refrigerator of claim 19, wherein the slack accommodating structure further includes a protrusion allowing the supplemental guide to rotate downwards when the door is closed.

27. The refrigerator of claim 26, wherein the protrusion is located in the compartment to be in contact with an upper part of the supplemental guide to force the supplemental guide to rotate downwards when the door is closed.
